(19) United States
(12) Patent Application Publication
(10) Pub. No.: US 2005/0005140 A1
(43) Pub. Date: Jan. 6, 2005

(54) Data processing device

(75) Inventors: Gernot Eckstein, Neufahm (DE); Thomas Kunemund, Munchen (DE); Holger Sedlak, Sauerlach (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 10/864,822

(22) Filed: Jun. 8, 2004

Related U.S. Application Data
(63) Continuation of application No. PCT/DE02/04322, filed on Nov. 25, 2002.

(30) Foreign Application Priority Data
Dec. 27, 2001 (DE) 101 64 174.5

(51) Int. Cl. H04L 9/00

(52) U.S. Cl. 713/189

(57) ABSTRACT

A data processing device having a bus system, encryption devices for encrypting and decrypting information transmitted on the bus system, and at least one key change device for exchanging a key used. The keys used are changed automatically at irregular time intervals, which are preferably defined by a random number with the aid of an automatic state machine.

### CROSS-REFERENCE TO RELATED APPLICATION

This application is a continuation of International Patent Application Serial No. PCT/DE02/04322, filed Nov. 25, 2002, which published in German on Jul. 10, 2003 as WO 03/056747, and is incorporated herein by reference in its entirety.

### FIELD OF THE INVENTION

The invention relates to a data processing device with a bus system and encryption devices for encrypting and decrypting information transmitted on the bus system, and with at least one key change device for exchanging the key used.

### BACKGROUND OF THE INVENTION

The encryption of internal data on buses and in memories is an important measure to counter attacks on security-sensitive circuits. Encrypted data read out by unauthorized third parties are generally worthless, so that a purely physical access to the bus lines or other data lines no longer leads to the attacker's goal, namely obtaining information about the internal sequences of the data processing device and the stored or processed data. The goal of an attack must then be, in the first instance, the determination of the key respectively used.

In order to increase the security, it is known to exchange the key after a specific time. The time which remains for an attacker to determine the key used and to read out the data is thus limited. In the case of stringent security requirements, it is customary to exchange the key at very short time intervals. Although this leads to an increased security for the data and a good protection against attackers, a frequent key change nevertheless increases the current consumption of the circuit to a great extent. This can be explained by the fact that on average 50% of the registers which are used in the data processing device have to be changed during a key change. In addition to the problems of heating of the semiconductor circuits known in the case of data processing devices, the problem arises, particularly in the case of contactless smart cards, that the available power for operating the data processing device is very low since it must also be transmitted contactlessly to the smart card.

If the current consumption is to be kept so low as to allow use in a contactless smart card, a frequent key change cannot be carried out; in other words, it is necessary to cut back on the security of the data processing device.

### SUMMARY OF THE INVENTION

It is an object of the invention, therefore, to specify a data processing device which not only ensures high security for the information transmitted on a bus system but also has a low current consumption.

This object is achieved by means of a data processing device of the type mentioned in the introduction which is characterized in that the keys used are changed automatically at irregular time intervals.

A successful attack, for example by differential current profile analysis, comprises a statistical analysis of operations carried out in the data processing device. Changing the key used at irregular time intervals in accordance with the invention therefore makes it more difficult to employ the abovementioned analysis method since it cannot be predicted when a key change will take place.

In this case, it is particularly advantageous if the instant at which the key is changed is determined by a random number since this means that the instant at which the key is changed cannot be predicted even by complex calculations.

In an advantageous embodiment, the data processing device has at least one key change device which carries out a key change when a key change signal is present, the key change signal being generated by a device for generating a key change signal, with a clock divider ratio definer which has an automatic state machine, predetermined clock divider ratios each being assigned at least one state and state changes being dependent on the significance of a random signal, and a clock divider ratio controller which is connected to the clock divider ratio definer and by which the key change signal can be generated from a regular clock signal in accordance with the clock divider ratio defined by the state of the automatic state machine.

Further advantageous refinements of the invention are specified in the subclaims.

### BRIEF DESCRIPTION OF THE DRAWINGS

The invention is explained in more detail below using an exemplary embodiment. In the figures:

FIG. 1 shows a block diagram with essential components of a data processing device according to the invention,

FIG. 2 shows a state graph of the clock divider ratio definer, and

FIG. 3 shows a circuit arrangement for realizing a clock divider ratio definer.

### DETAILED DESCRIPTION OF THE PREFERRED MODE OF THE INVENTION

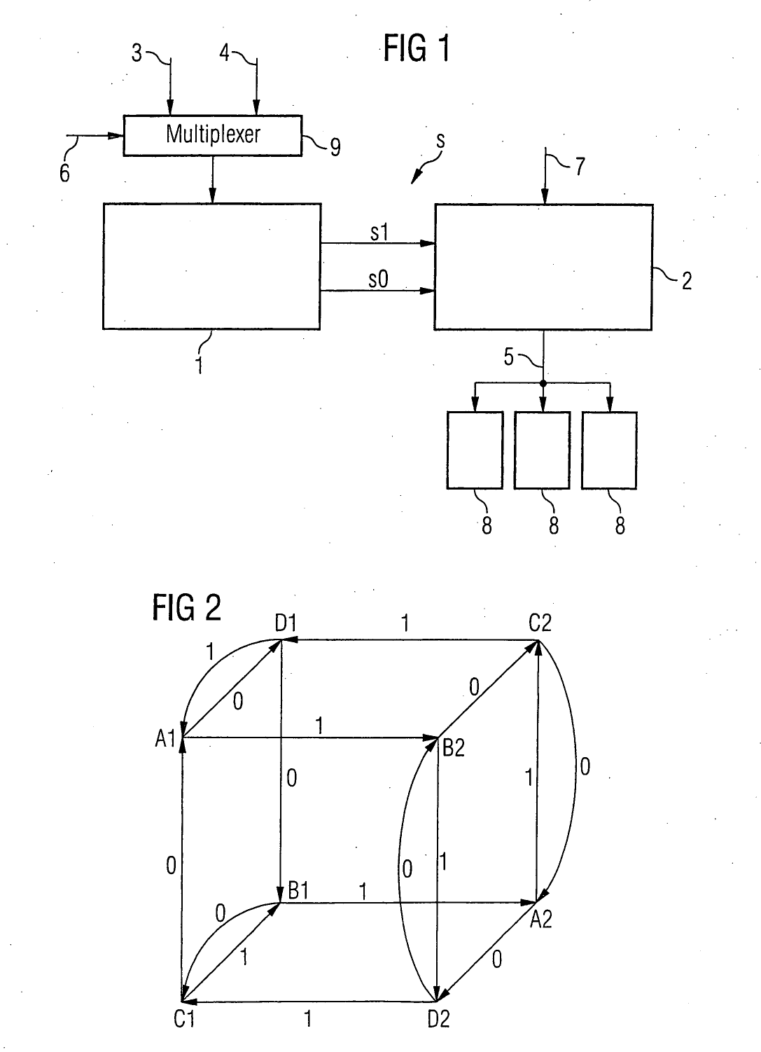

FIG. 1 illustrates a block diagram of a data processing device according to the invention. In this case, key change devices 8 assigned to encryption devices are provided, and can in each case change the key required for encrypting and decrypting data at the instigation of a key change signal 5. The key change signal 5 is generated by a clock divider ratio controller 2. The latter has an input for a periodic clock signal 7 and is furthermore connected to a clock divider ratio definer 1, from which it receives a signal s with two bits s0 and s1. The clock divider ratio controller 2 filters out pulses from the clock signal 7 in accordance with the signal s that it receives from the clock divider ratio definer 1. In this case, the signal s defines which clock divider ratio A, B, C, D predetermined by the clock divider ratio controller is to be used for this purpose. The following clock divider ratios are provided in this exemplary embodiment:

| A | B | C | D |
|---|---|---|---|
| 1:2 | 1:4 | 1:6 | 1:8 |

Which of the four clock divider ratios is to be employed is determined by the four possibilities of the number s0, s1. In a concrete realization, the clock divider ratio controller is realized by a controllable counter which can count up to 2, 4, 6 and 8. Such a counter can be taken from the prior art.

The core of the invention is that the key used is changed automatically at irregular time intervals. This is realized by a clock divider ratio definer 1 driven by a random number 3 or 4. In the exemplary embodiment of FIG. 1, the random number has a length of 1 bit. This may be either a pseudo-random bit 3 or a genuinely random bit 4. A pseudo-random bit can be generated in accordance with the prior art, for example by a voltage-controlled oscillator with a feedback shift register connected downstream. A genuinely random bit 4 can be generated by a noise source. In the exemplary embodiment of FIG. 1, it is provided that one of said random numbers can be selected by a multiplexer 9. However, this is optional. It suffices for a pseudo-random random number 3 or a genuinely random random number 4 to be fed directly to the clock divider ratio definer.

The text below describes, with reference to FIG. 2, how, in an advantageous embodiment, one of the predetermined clock divider ratios is selected from the random number. An automatic state machine is provided in the embodiment described. This is an ambiguous automatic machine, but this is not a condition for the implementability of an automatic state machine for a data processing device according to the invention. An unambiguous automatic machine could also be involved in another embodiment.

As described above, four predetermined clock divider ratios are provided. Each of these clock divider ratios is assigned two states of the automatic state machine, resulting in a total of eight states. Through the universal coding of the automatic machine, each of the original four states is adjacent to every other, in accordance with the four clock divider ratios. The coding is provided such that exactly one bit changes during each state transition (one shot coding). The eight states are designated by A1, A2, B1, B2, C1, C2, D1 and D2 in FIG. 2. The transition from one state to another is determined in each case by the random bit. Proceeding from an arbitrary starting point, the following possible sequences result for the subsequent clock divider ratios. The clock divider ratio A is chosen as the starting point, without restricting the generality:

| | | | | |
|---|---|---|---|---|
| I | A | B | C | D |
| II | A | B | D | C |
| III | A | C | B | D |
| IV | A | C | D | B |
| V | A | D | C | B |
| VI | A | D | B | C |

On account of the assignment of two states per clock divider ratio, it is thus possible to pass to any other clock divider ratio by means of a single state change. By way of example, although one passes from the state A1 only to the states B2 and D1 (in accordance with the clock divider ratios B and D, respectively), one does not pass to the clock divider ratio C. However, one can pass from A2 to the state C2, that is to say the clock divider ratio C2.

The one shot coding is realized in the exemplary embodiment by providing the following assignment:

| | |
|---|---|
| A1 | 001 |
| A2 | 110 |
| B1 | 010 |
| B2 | 101 |
| C1 | 000 |
| C2 | 111 |
| D1 | 011 |
| D2 | 100 |

The two signals s0 and s1 are then produced from the states of the automatic machine and transferred to the clock divider ratio controller 2.

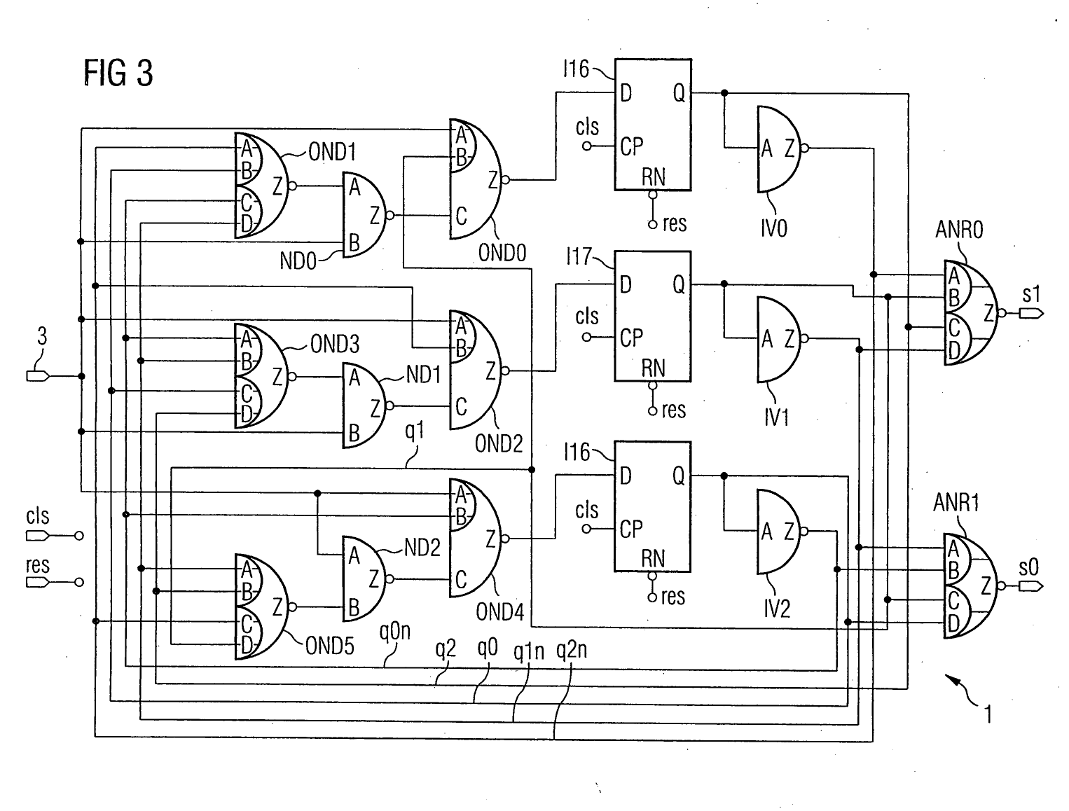

FIG. 3 specifies a circuit arrangement for the implementation of the clock divider ratio definer 1. The random signal 3 is present at the input. Furthermore, a clock signal CLS and a reset signal RES are provided. At the output, two signals s0 and s1 are output for forwarding to the clock divider ratio controller. The circuit only comprises logic combination elements and three flip-flops. As a result, the circuit can be realized very simply. However, the concrete configuration of a circuit arrangement as shown in FIG. 3 is to be regarded only as one of many possibilities, which lies within the ability of a person skilled in the art and is not, therefore, described in detail. However, the embodiment shown is advantageous insofar as it is evidently constructed symmetrically, which has a favorable effect on the current profile.

The exemplary embodiment shown can be generalized by varying the number of possible clock divider ratios and by the number of random bits on the basis of which a decision is taken about the next divider ratio.

The circuit described makes attacks on security circuits more difficult by an irregular key change. The basis of this embodiment is the largely uniformly distributed and thus practically random variation of the clock divider ratio from which is derived the clock for the key change, i.e., the key change signal.

A reduction in the current consumption by the factor 2.5 results for the exemplary embodiment specified. The system security is not impaired in this case compared with a solution from the prior art. In the case of clock divider ratios greater than 1:8, further advantages result for the current consumption, but this is to the detriment of the security. The stringency of the requirements made of the data security depends on the respective case of use. Therefore, in one development of the invention, programmability of the clock divider ratios that can be used is conceivable, so that in the concrete case of use it is possible to define whether a high security or a low current consumption is to be given priority.

1. A data processing device comprising:
a bus system;
encryption devices that encrypt and decrypt information transmitted on the bus system; and
at least one key change device for changing a key rquired for encrypting and decrypting the information transmitted in the bus system,
wherein the key is changed automatically at irregular time intervals.

2. The data processing device as claimed in claim 1, wherein an instant at which the key is changed is determined by a random number.

3. The data processing device as claimed in claim 2, wherein when a key change signal is present at the at least one key change device, the at least one key change device carrying out a key change, the key change signal being generated by a device for generating a key change signal that comprises:
a clock divider ratio definer which has an automatic state machine, predetermined clock divider ratios each being assigned at least one state, and state changes being dependent on a significance of a random signal; and
a clock divider ratio controller which is connected to the clock divider ratio definer and by which the key change signal can be generated from a regular clock signal in accordance with the clock divider ratio defined by the state of the automatic state machine.

4. The data processing device as claimed in claim 3, wherein the random number is a one-bit number.

5. The data processing device as claimed in claim 4, wherein the automatic state machine is non-unambiguous.

6. The data processing device as claimed in claim 5, wherein four predetermined clock divider ratios are provided and each clock divider ratio is assigned two states.

7. The data processing device as claimed in claim 1, wherein the data processing device is a smart card.

8. The data processing device as claimed in claim 7, wherein the smart card is a contactless smart card.

9. The data processing device as claimed in claim 3, wherein the predetermined clock divider ratios can be defined by means of a programming interface.
